(19) United States
(12) Patent Application Publication
(10) Pub. No.: US 2013/0042861 A1
(43) Pub. Date: Feb. 21, 2013

(54) HELMET-TYPE PERSONAL DISASTER RELIEF DEVICE

(71) Applicant: Jong-tae Baek, Daejeon (KR)

(72) Inventor: Jong-tae Baek, Daejeon (KR)

(73) Assignee: CIJ CORPORATION, Daejeon (KR)

(21) Appl. No.: 13/643,587

(22) PCT Filed: Apr. 26, 2011
(86) PCT No.: PCT/KR2011/003043

§ 371 Date: Nov. 2, 2012

(30) Foreign Application Priority Data
Apr. 26, 2010 (KR) 10-2010-0038288

(51) Int. Cl. A62B 18/04; A62B 18/10

(52) U.S. Cl. 128/201.25; 128/201.28

(57) ABSTRACT

Provided is a helmet-type personal disaster relief device which supplies fresh air to a wearer during an evacuation time period upon the occurrence of disasters, and protects the skin of the face, neck and shoulders of the wearer. For this purpose, the helmet-type personal disaster relief device of the present invention comprises a helmet body having an outer shell, an inner shell formed inside the outer shell, and an air storage space formed between the outer shell and the inner shell. to store compressed air; an air inlet port open/shut device arranged at an air inlet port which is formed at the outer shell to inject air into the air storage space; an air outlet port open/shut device which is arranged in an internal space of the helmet body to open/shut an air outlet port for discharging the compressed air stored in the air storage space to the space where the wearer breaths; an air outlet port open/shut device operating device installed in the outer shell to operate the air outlet port open/shut device; and a transparent window formed at the front surface of the outer shell.

### TECHNICAL FIELD

The present invention relates to a helmet-type personal disaster relief device, and more particularly, to a helmet-type personal disaster relief device capable of supplying fresh air to a wearer during an evacuation period of time upon the occurrence of a disaster and protecting a face, a neck, and a shoulder of a wearer.

### BACKGROUND ART

A fire upon the occurrence of disasters generates heat and flame, toxic gases, and the like, that are by-products of the heat and flame. When a fire occurs, an inside of a building is filled with smoke and harmful gases within a short period of time causing a person to become unconscious even if they breathe one or two breaths of smoke and harmful gases. Therefore, when a fire occurs, a person suffocates due to breathing in harmful gases, smoke, or by heat (or heated gases), and the like, rather than dying directly by fire, or the like.

According to the statistics, it has been investigated that upon the occurrence of a fire, the cause of death by haze, toxic combustion gases, and heated gases is about 70%. As described above, a solution to prevent deaths caused by haze, toxic combustion gases, and heated gases upon an accidental fire accident has been urgently required.

### DISCLOSURE

### Technical Problem

The present invention proposes to improve the foregoing related art (in the past, evacuating while covering a nose with a wet towel) and an object of the present invention is to supply compressed air in a storage space to a breathing space within a helmet body by wearing a helmet according to the present invention under the dangerous situations such as toxic gases, heated gases, oxygen deficiency, and the like, in case of emergency and operating an air outlet port open/shut device operating device, thereby enabling a wearer to breathe fresh air for a predetermined period of time required for evacuation. Further, an object of the present invention is to provide a helmet-type personal disaster relief device capable of preventing a wearer from suffering from a suffocation or fatal accident due to harmful gases and heated gases by maintaining a breathing space of a wearer in a positive pressure.

Another object of the present invention is to provide a helmet-type personal disaster relief device capable of preventing burns to a skin of the face, neck, and shoulder, hair, and the like, due to a flame or heated gases.

Still another object of the present invention is to provide a helmet-type personal disaster relief device including a foldable body and an air storage pack that are formed of flexible materials easily foldable by an external force to expel air at the time of carrying and storing so as to reduce the size, thereby supplying air in case of emergency while being easily carried and stored.

### Technical Solution

In one general aspect, a helmet-type personal disaster relief device for supplying air in case of emergency, includes: a helmet body 400 having an outer shell 410, an inner shell 420 formed inside the outer shell 410, and an air storage space S formed between the outer shell 410 and the inner shell 420 to store compressed air; an air inlet port open/shut device 411 arranged at an air inlet port which is formed at the outer shell 410 to inject air into the air storage space S; an air outlet port open/shut device 510 which is arranged in an internal space of the helmet body 400 to open/shut an air outlet port 421 for discharging the compressed air stored in the air storage space S to a breathing space H where a wearer breaths; an air outlet port open/shut device operating device 520 installed in the outer shell 410 to operate the air outlet port open/shut device 510; and a transparent window 600 formed at the front of the outer shell 410.

In the present invention, the air inlet port open/shut device 411 may be a back flow prevention valve for preventing a back flow of air.

In the present invention, the air outlet port 421 may be formed in the inner shell 420, the air outlet port open/shut device 510 may include a rotating plate 511 rotatably installed in the inner shell 420 so as to open/shut the air outlet port 421 according to the rotation, and the air outlet port open/shut device operating device may have a lower end connected with the air outlet port open/shut device 510 and includes a rotating shaft 521 having an upper end protruded to an upper portion of the outer shell 410.

The helmet-type personal disaster relief device for supplying air in case of emergency may further include: a neck cover 700 formed of a flexible material having elasticity and connected with a lower end of the helmet body 400 so as to surround a neck of a wearer; a neck cover tension rope 710 installed in the neck cover 700 so as to control the amount of air discharged through a lower end of the neck cover 700; and a shoulder cover 700-1 formed of an insulating and flexible material and connected to the lower end of the neck cover 700 so as to surround a neck and a shoulder of a wearer.

In the present invention, a wireless communication module 810 transmitting a location of the wearer to an external control center and formed to allow a wearer to receive an evacuation route information from the external control center may be installed in the outer shell 410.

In the present invention, the wireless communication module 810 may be operated together with the air outlet port open/shut device 510 so that the wireless communication module 810 is operated while the air outlet port open/shunt device 510 opens the air outlet port 421.

In the present invention, an upper portion of the outer shell 410 may be provided with an emergency light 820 operated when a fire alarm device installed in a building rings and a front of the outer shell 410 may be provided with a lamp 830 so as to secure a wearer's field of vision.

In the present invention, the helmet body 400 may be formed of a flexible material and include an air storage pack formed of a flexible material and forming the air storage space S.

In the present invention, the compressed air stored in the air storage space S may be discharged to the breathing space H from the air storage space S by operating the air outlet port open/shut device 510 to maintain an air pressure of the breathing space H so as to be higher than the external air pressure of the helmet body 400.

In the present invention, the compressed air stored in the air storage space S may be compressed oxygen.

An inside of the helmet body 400 may be further provided with a carbon dioxide absorbing member and a dehumidifying agent.

### Advantageous Effects

According to the embodiments of the present invention, it is possible to supply fresh air stored in the air storage space to a wearer for an evacuation period of time upon the occurrence of disasters. Therefore, according to the embodiment of the present invention, it is possible to prevent causalities due to suffocation caused by harmful gases and heated gases upon the occurrence of disasters, in particular, the occurrence of a fire.

Further, according to the embodiments of the present invention, it is possible to prevent external toxic air (water upon the occurrence of drowning accident) from being permeated into the breathing space by maintaining the breathing space of a wearer at a positive pressure.

Further, according to the embodiments of the present invention, it is possible to prevent burn to the skin of the face, neck, and shoulder, hair, and the like, that may occur due to flames by protecting a head, a neck, and a shoulder, including a face with an insulating material. In particular, according to the embodiments of the present invention, it is possible to interrupt the injection of external heated gases, and the like, into the breathing space by maintaining the breathing space of a wearer at a positive pressure.

Further, according to the embodiment of the present invention, it is possible to prevent external air of the helmet body from being permeated into the breathing space while discharging air in the breathing space to the outside of the helmet body from the breathing space by maintaining the air of the breathing space at a positive pressure.

Further, according to the embodiments of the present invention, it is possible to prevent burn to a wearer while preventing the damage of the helmet upon the occurrence of a fire by forming the outer shell with the heat-resistant insulating material. In particular, according to the embodiment of the present invention, it is possible to freshly store air stored in the helmet body by forming the inner shell of the helmet with Teflon-based materials. In addition, the embodiments of the present invention can treat the transparent window with the anti-fog coating materials or can form the transparent window with the heat-resistant insulating material.

Further, according to the embodiments of the present invention, it is possible to control the amount of air discharged to the outside of the helmet body from the breathing space by using the tension rope provided at the neckpiece.

Further, according to the embodiments of the present invention, it is possible to allow a wearer to easily find the helmet and easily locate a wearer by operating the emergency light together with the fire alarm device and turning on the emergency light of the helmet while operating the fire alarm device upon the occurrence of a fire.

Further, according to the embodiments of the present invention, it is possible to secure a wearer's field of vision due to the mounted lamp, even at a place where it is difficult to secure the field of vision due to darkness, smoke, and the like.

Further, according to the embodiments of the present invention, it is possible to transmit a location of a wearer to the external control center in case of emergency by including the wireless communication module and rapidly evacuate a wearer to a safe place by allowing a wearer to receive the evacuation route information from the external control center.

Further, according to the embodiments of the present invention, it is possible to expel air at the time of carrying and storing so as to reduce the size of the helmet body and the air storage pack with the flexible materials that can be folded by the external force, thereby facilitating the carrying and storing.

### DESCRIPTION OF DRAWINGS

The above and other objects, features and advantages of the present invention will become apparent from the following description of preferred embodiments given in conjunction with the accompanying drawings, in which:

FIG. 1 is a side view of a helmet-type personal disaster relief device according to an embodiment of the present invention; FIG. 2 is the side cross-sectional view of a helmet-type personal disaster relief device according to the embodiment of the present invention;

FIG. 3 is a diagram for describing a configuration and an operation of an air outlet port open/shut device and an air outlet port open/shut device operating device in the helmet-type personal disaster relief device according to the embodiment of the present invention;

FIG. 4 is a diagram illustrating that an external air supply pack is further installed in the helmet-type personal disaster relief device according to the embodiment of the present invention;

FIG. 5 is a diagram illustrating that a shoulder cover is further installed in the helmet-type personal disaster relief device according to the embodiment of the present invention; and

FIGS. 6 and 7 are diagrams for describing a configuration of a helmet-type personal disaster relief device according to another embodiment of the present invention.

### BEST MODE

Embodiments of the present invention will be described in detail with reference to the accompanying drawings. Herein, repeated descriptions and detailed descriptions related to well-known functions or configurations will be ruled out in order not to unnecessarily obscure the subject matter of the present invention. Embodiments of the present invention are provided to more completely describe the present invention to a skilled in the art to which the present invention pertains.

Therefore, a shape, a size, and the like, of components may be exaggerated in the drawings for more clear description.

Hereinafter, a configuration and an operation of a helmet-type personal disaster relief device according to an embodiment of the present invention will be described.

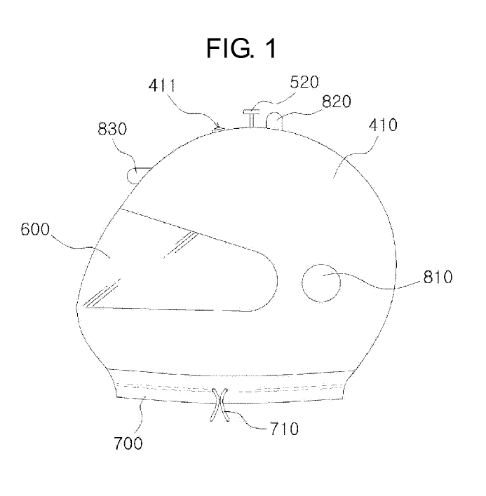

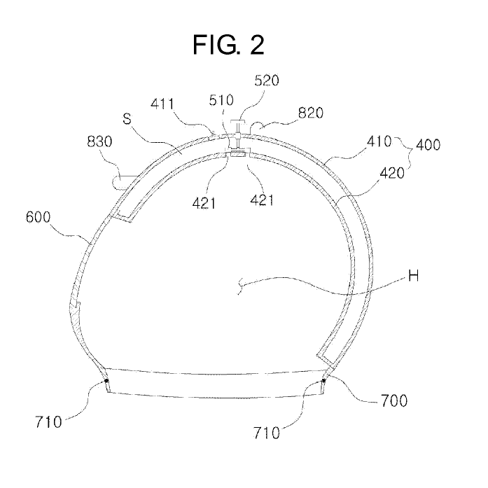

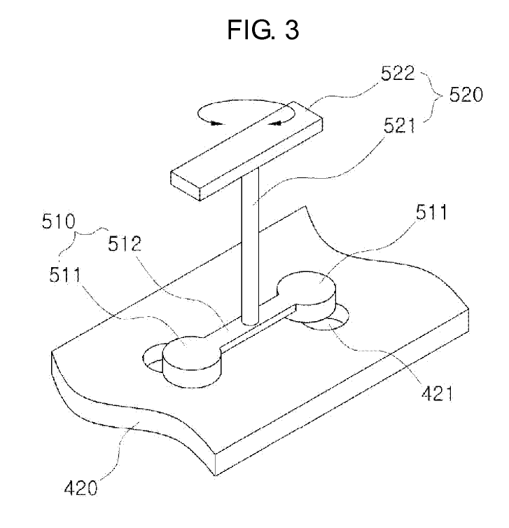

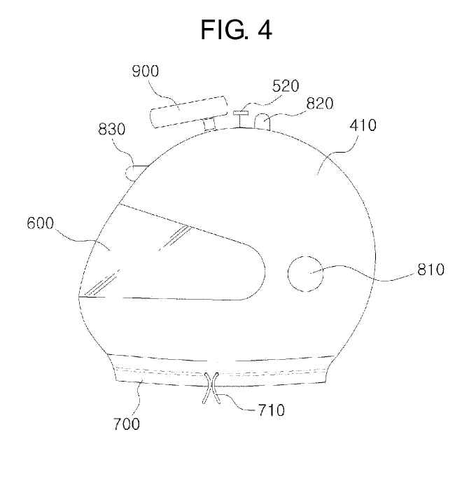

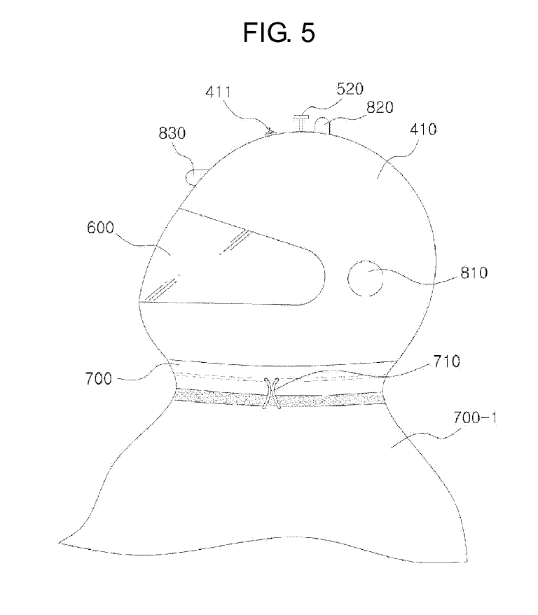

FIG. 1 is a side view of a helmet-type personal disaster relief device according to an embodiment of the present invention. FIG. 2 is the side cross-sectional view of a helmet-type personal disaster relief device according to the embodiment of the present invention. FIG. 3 is a diagram for describing a configuration and an operation of an air outlet port open/shut device and an air outlet port open/shut device operating device in the helmet-type personal disaster relief device according to the embodiment of the present invention. FIG. 4 is a diagram illustrating that an external air supply pack is further installed in the helmet-type personal disaster relief device according to the embodiment of the present invention. FIG. 5 is a diagram illustrating that a shoulder cover is further installed in the helmet-type personal disaster relief device according to the embodiment of the present invention.

Referring to FIGS. 1 and 2, the helmet-type personal disaster relief device according to the embodiment of the present invention includes a helmet body 400 that includes an outer shell 410 and an inner shell 420.

Referring to FIG. 2, an air storage space S is formed between the inner shell 420 and the outer shell 410. The air storage space S may be stored with a compressed air or compressed oxygen. An inside of the helmet body 400, that is, an inside of the inner shell 420 may be further provided with a carbon dioxide absorbing member. Therefore, internal air of the helmet body 400 may be freshly maintained regardless of a breath of a wearer. Further, the inside of the helmet body 400, that is, the inside of the inner shell 420 may be further provided with a dehumidifying agent. Therefore, it is possible to prevent a fogging up on a transparent window 600 to be described below.

Referring to FIG. 2, the outer shell 410 is provided with an air inlet port (reference numeral is not granted) for injecting air into the air storage space S. The air inlet port (reference numeral is not granted) is a passage for injecting air into the air storage space S.

Referring to FIGS. 1 and 2, the air inlet port (reference numeral is not granted) is provided with an air inlet port open/shut device 411 for opening and shutting the air inlet port (reference numeral is not granted). The air inlet port open/shut device 411 may be a back flow prevention valve for preventing a back flow of air to an outside from the air storage space S. An air filter may be attached to the air inlet port (reference numeral is not given).

Referring to FIGS. 2 and 3, the inner shell 420 is provided with an air outlet port 421 for discharging air stored in the air storage space S to the inside of the inner shell 420. The air outlet port 421 may be provided with an air filter.

Referring to FIGS. 2 and 3, an air outlet port open/shut device 510 for opening and shutting the air outlet port 421 may be installed in the air storage space S. The air outlet port open/shut device 510 includes rotating plates 511 and a rotating plate connecting rod 512 connecting the rotating plates 511 facing each other. The air outlet port open/shut device 510 is installed to control a discharge amount of air that is discharged through the air outlet port 421 by opening and shutting the air outlet port 421 by rotating the rotating plate 511 according to the rotation of the rotating plate connecting rod 512 based on its own central point. That is, the compressed air stored in the air storage space S is discharged from the air storage space S to a breathing space H by the operation of the air outlet port open/shut device 510 so that an air pressure of the breath space H may be maintained so as to be higher than the external air pressure of the helmet body 400.

Referring to FIGS. 2 and 3, the air outlet port open/shut device 510 is connected with an air outlet port open/shut device operating device 520. A lower end of the air outlet port open/shut device operating device 520 is connected with a central portion of the rotating plate connection rod 512 and includes a rotating shaft 521 having an upper end protruded to an outside of the outer shell 410 and a rotating shaft lever 522 installed in the upper end of the rotating shaft 521. The rotating shaft 521 is rotatably installed in the outer shell 410 and a sealing member may be installed between the outer shell 410 and the rotating shaft 521 for airtight.

Referring to FIG. 4, the air inlet open/shut device 411 may be connected with an external air supply pack 900. When the air in the air storage space S is discharged to the internal space of the helmet body 400 that is the space H where the wearer breathes through the air outlet port 421 by installing the external air supply pack 900 in the air inlet open/shut device 411, the air in the external air supply pack 900 is injected into the air storage space S. The external air supply pack 900 can be used when an additional amount of air is required in addition to the amount of air stored in the storage space S due to a delay of the evacuation period of time. As the external air supply pack 900, an air supply can and an air supply pocket can be used.

Referring to FIGS. 1 and 2, a front of the outer shell 410 is provided with the transparent window 600. The transparent window 600 is to secure a wearer's field of vision. The transparent window 600 may be coated with an anti-fog coating material and the transparent window 600 may be formed of a heat-resistant insulating material.

Referring to FIGS. 1 and 2, lower ends of the outer shell 410 or the inner shell 420 are connected with a neck cover 700 surrounding a neck of a wearer. The neck cover 700 is formed of a heat-resistant insulating material and the neck cover 700 is also formed of a flexible material that has elasticity so as to be freely deformed by the external force. Therefore, the neck cover 700 may be formed of a non-inflammable cloth that is the heat-resistant insulating material, and the like. Meanwhile, the neck cover 700 is provided with a neck cover tension rope 710 so as to control the amount of air that is discharged through the lower end of the neck cover 700 by controlling a gap between the neck cover 700 and a neck of a wearer. It is possible for the neck cover tension rope 710 to control the amount of air discharged to the outside of the helmet body 400 from the breathing space. Therefore, it is possible to control the evacuation period of time.

Referring to FIG. 5, a lower end of the neck cover 700 may be connected with a shoulder cover 700-1 that can surround and protect a shoulder of a wearer. The shoulder cover 700-1 may be connected with the neck cover 700 by a Velcro, and the like. The shoulder cover 700-1 is to protect a body portion of a wearer covered by a wearer's neck, back, and shoulder cover 700-1 from flames and heat. The shoulder cover 700-1 may be formed of the same material as the neck cover 700.

Referring to FIG. 1, an upper portion of the outer shell 410 is provided with an emergency light 820. The emergency light 820 may be installed at a portion corresponding to a forehead of a wearer in the outer shell 410. When the fire alarm device is operated at the time of fire emergency by operating the emergency light 820 together with the fire alarm device installed in a building, the emergency light is “flashing” while issuing the fire alarm and thus, it is possible to easily find the helmet worn by an evacuee using the flashing emergency light. Further, the emergency light 820 may be configured to be operated while operating a wireless communication module 810 to be described below. Further, the emergency light 820 emits light when an evacuee wears the helmet and thus, can also be used to additionally locate the wearer.

Referring to FIG. 1, the front of the outer shell 410 is provided with a lamp 830. The lamp may be installed at a portion corresponding to a forehead of a wearer in the outer shell 410. It is easy to secure the wearer's field of vision due to the lamp 830 even at a place where it is difficult to secure a field of vision due to a smoke, and the like.

Referring to FIG. 1, the outer shell 410 is provided with the wireless communication module 810 for wireless communication with the external control center. The wireless communication module 810 is to allow a wearer to receive the evacuation route information from the external control center while transmitting a location of a wearer to the external control center and may be configured to include a transmitting and receiving chip, a control unit (MCU), a micro speaker, a power supply unit, an antenna, and the like. The embodiment of the present invention includes the wireless communication module to allow a wearer to receive the evacuation route information from the external control center while transmitting a location of a wearer to the external control center, thereby rapidly evacuating a wearer to a safe place in case of emergency.

Meanwhile, the wireless communication module 810 may be configured to be operated together with the air outlet port open/shut device 510. That is, when the air outlet port open/shut device 510 is operated in case of emergency, the air outlet port open/shut device 510 may be configured to operate the wireless communication module 810 while discharging the compressed air.

The wireless communication module 810 may be implemented by using a WiFi or Mobile infrastructure, using a GPS and a satellite communication scheme, using any one of a ultra wideband (UWB) using a ubiquitous sensor network (USN) scheme, Bluetooth, and Zigbee.

Referring to FIG. 5, the embodiment of the present invention may protect the entire head, neck, and shoulder, including a face by the body 400, the neck cover 700, and the shoulder cover 700-1 formed of an insulating material to prevent burns to the skin of the face, neck, and shoulder, hair, and the like and may interrupt the injection of external heated gases due to a positive pressure of the breathing space to prevent burns to the skin of the face, neck, and shoulder, hair, and the like that can occur due to the external heated gases.

A detailed operation of the helmet-type personal disaster relief device according to the embodiment of the present invention will be described below.

Referring to FIG. 2, when air is injected into the air storage space S through the air inlet port open/shut device 411 at a high pressure before a wearer wears the helmet, the high-pressure compressed air is stored in the air storage space S.

Referring to FIGS. 2 and 3, when a wearer of the helmet encounters an emergency situation such as a fire, and the like, the rotating shaft 521 may be rotated by the rotating shaft lever 522. When the rotating shaft 521 is rotated, the air outlet port 421 is opened by rotating the rotating plate 511 together with the rotating plate connecting rod 512. In this case, it is possible to control an opened degree of the air outlet port 421 by controlling a rotating angle of the rotating shaft 521, such that the amount of air discharged from the air storage space S to the breathing space H through the air outlet port 421. Meanwhile, the air inlet port open/shut device 411 and the air outlet port 421 may also be formed as one body.

Referring to FIG. 2, in the case in which the opening/shutting member of the air outlet port 421 is opened, the breathing space H in the helmet is filled with fresh positive pressure air when the compressed air is discharged from the air storage space S to the breathing space H and a wearer of a helmet can breathe the fresh air.

In particular, the air outlet port 421 is disposed on the upper portion of the helmet body 400, the air discharged from the air outlet port 421 flows in a neck portion via a forehead, a nose, and the like, from a head of a wearer and is discharged to the outside through the neck cover 700 on the lower portion of the helmet. Here, when an air pressure of the breathing space H filled with the positive pressure is set to be P1 and an air pressure outside the helmet is set to be P2 (P2 is normally 1 atmospheric pressure), a difference ΔP in air pressure between the breathing space H and the outside of the helmet becomes ΔP=P1−P2.

According to the embodiment of the present invention, when air is compressed and stored in the air storage space S, the air pressure of the breathing space H is maintained at a positive pressure as much as ΔP as compared with the air pressure outside the helmet. Therefore, the positive pressure air of the breathing space H is discharged outside the helmet, but the air (water upon the occurrence of a drowning accident) outside the helmet that is a negative pressure does not permeate into a breathing space H. Therefore, even though the external air is formed of harmful gases or heated gases due to a fire, and the like, a wearer may suck fresh air and therefore, may prevent causalities due to suffocation, an accident, and the like, caused by harmful gases and heated gases.

The difference ΔP in air pressure between the breathing space H and the outside of the helmet may be controlled by controlling the rotating angle of the rotating shaft 521 to control the opened degree of the air outlet port 421.

Referring to FIGS. 1 and 2, the gap between the neck cover 700 and the neck of the wearer is controlled by pulling or releasing the tension rope 710 to control the amount of air discharged to the outside of the helmet from the breathing space H. The emergency evacuation period of time may extend according to the control of the tension rope 710.

Further, the embodiment of the present invention controls a ratio of oxygen in the air stored in the air storage space S to control an oxygen ratio of the compressed air supplied to the breathing space H from the air storage space S. It is possible to extend the emergency evacuation period of time according to the increase in an oxygen ratio of the air stored in the air storage space S from the outside.

Further, the embodiment of the present invention may improve freshness and quality of air supplied to a wearer by adding perfume such as aloma, and the like, to the air stored in the air storage space S.

Referring to FIG. 1, it is possible to transmit location information of a wearer to a central information server of the external control center through the wireless communication module 810. The central information server can track the location information of the wearer in real time by displaying the location information using a display unit. Further, the central information server generates the route information on a section in which the location information is received by using the location information transmitted from the wireless communication module 810. For example, the central information server may maintain map data about at least one zone. Therefore, the central information server may display the current location of the wearer on the map at the time of receiving the location information from the wireless communication module 810. In this case, it is possible to provide the evacuation route, and the like, to the wearer as information such as voice, and the like, by using the location information of the wearer. By doing so, the wearer can escape more rapidly during the critical situation.

When the wearer cannot move due to an injury, the current location of the wearer can be detected by receiving the location information of the wearer transmitted from the wireless communication module 810, such that a rescuer is dispatched by using the detected location information to rescue the wearer.

Hereinafter, a configuration and an operation of a helmet-type personal disaster relief device according to another embodiment of the present invention will be described.

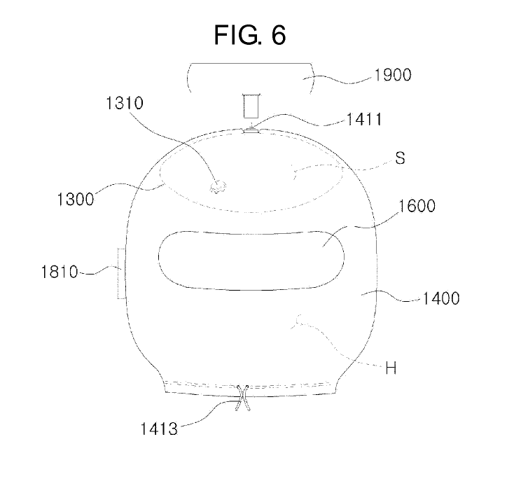

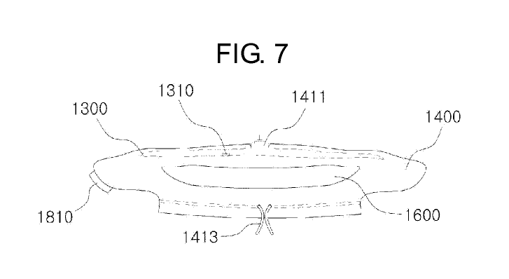

FIGS. 6 and 7 are diagrams for describing a configuration of a helmet-type personal disaster relief device according to another embodiment of the present invention.

Referring to FIGS. 6 and 7, the helmet-type personal disaster relief device according to another embodiment of the present invention includes a foldable body 1400, an air storage pack 1300 in the body 1400, an air inlet port open/shut device 1411, an air outlet port open/shut device 1310, a transparent window 1600, a wireless communication module 1810, and an external air supply pack 1900.

Referring to FIGS. 6 and 7, the helmet-type personal disaster relief device according to another embodiment of the present invention includes a helmet-type foldable body 1400. The foldable body 1400 can be worn on a head and is formed of a flexible material that can be foldable by the external force of a person. The foldable body 1400 is formed of a heat-resistant insulating material.

Referring to FIGS. 6 and 7, the foldable body 1400 is provided with the air inlet port open/shut device 1411 for injecting the compressed air. The air inlet port open/shunt device 1411 is formed above the foldable body 1400. The air inlet port open/shut device 1411 may be configured of a back flow prevention valve like the helmet-type personal disaster relief device according to the embodiment of the present invention.

Referring to FIG. 6, the air storage pack 1300 is installed in the foldable body 1400 so as to store air. That is, the air storage space in which air may be stored is formed in the air storage pack 1300. The air storage pack 1300 is connected with the air inlet port open/shut device 1411 so as to store the compressed air through the air inlet port open/shut device 1411. Referring to FIG. 8, the air storage pack 1300 is formed of a flexible material that can be folded by the external force when air is not stored.

Referring to FIGS. 6 and 7, the air storage pack 1300 is provided with the air outlet port (not illustrated) so as to discharge the air stored in the air storage pack 1300 to the breathing space that is the space where the wearer breathes as the internal space of the foldable body 1400. The air outlet port (not illustrated) is provided with the air outlet port open/shut device 1310 for opening/shutting the air outlet port (not illustrated). Therefore, the evacuee operates the air outlet port open/shut device 1310 to discharge the fresh air to the breathing space from the air storage pack 1300 according to the installation of the foldable body 1400 in the state in which the air outlet port (not illustrated) is opened. The air outlet port open/shut device 1310 may be formed to control the amount of air discharged through the air outlet port (not illustrated).

Referring to FIGS. 6 and 7, the air inlet port open/shut device 1411 may be connected with the external air supply pack 1900. When the air in the storage space is discharged to the suction air through the air outlet port (not illustrated) as the external air supply pack 1900 is installed in the air inlet port open/shut device 1411, the air in the external air supply pack 1900 is injected into the air storage space. The external air supply pack 1900 can use the additional amount of air in addition to the amount of air stored in the storage space, if necessary, due to the delay of the evacuation period of time, and the like. As the external air supply pack 1900, the air supply can and the air supply pocket can be used.

Referring to FIGS. 6 and 7, the front of the foldable body 1400 is provided with the transparent window 1600. The transparent window 1600 is formed of the heat-resistant insulating and anti-fog prevention coating material.

Referring to FIGS. 6 and 7, the lower portion of the foldable body 1400 is provided with the tension rope 1413. The tension rope 1413 can control the amount of air discharged to the outside from the suction space of the foldable body 1400 through the lower portion of the foldable body 1400.

Referring to FIGS. 6 and 7, the foldable body 1400 is provided with the wireless communication module 1810 for wireless communication with the external control center. The wireless communication module 1810 is to receive the evacuation route information from the external control center while transmitting the location of the wearer to the external control center and may be configured to include the transmitting and receiving chip, the control unit (MCU), the micro speaker, the power unit, and the antenna.

Even in the case of the helmet-type personal disaster relief device according to another embodiment of the present invention, the wireless communication module 1810 may be configured to be operated together with the air outlet port open/shut device 1310. That is, when the air outlet port open/shut device 1310 is operated in case of emergency, the wireless communication module 1810 may be configured to be operated while the compressed air is discharged.

When even the helmet-type personal disaster relief device according to another embodiment of the present invention is installed in a building in a foldable form, the helmet-type personal disaster relief device can be configured to operate the emergency light (not illustrated) when the fire alarm device installed in a building rings.

According to the helmet-type personal disaster relief device according to another embodiment of the present invention, the foldable body 1400 and the air storage pack 1300 are formed of a flexible material that can be folded by the external force and therefore, air is expelled at the time of carrying and storing so as to reduce the volume, thereby being easily carried and stored.

Meanwhile, in the case of the helmet-type personal disaster relief device according to another embodiment of the present invention, the air inlet port open/shut device 1411 and the air outlet port open/shut device 1310 may be formed as one body.

As set forth above, the helmet-type personal disaster relief device according to the embodiment of the present invention is not limited to the configuration and method of the foregoing embodiments, but the whole or a part of the embodiments may also be configured by being selectively combined so as to variously changed.

1. A helmet-type personal disaster relief device for supplying air in case of emergency, comprising:
a helmet body having an outer shell, an inner shell formed inside the outer shell, and an air storage space (s) formed between the outer shell and the inner shell to store compressed air;
an air inlet port open/shut device arranged at an air inlet port which is formed at the outer shell to inject air into the air storage space (s);
an air outlet port open/shut device which is arranged in an internal space of the helmet body to open/shut an air outlet port for discharging the compressed air stored in the air storage space (s) to a space (h) where a wearer breaths;
an air outlet port open/shut device operating device installed in the outer shell to operate the air outlet port open/shut device; and
a transparent window formed at the front of the outer shell.

2. The helmet-type personal disaster relief device for supplying air in case of emergency of claim 1, wherein the air inlet port open/shut device is a back flow prevention valve for preventing a back flow of air.

3. The helmet-type personal disaster relief device for supplying air in case of emergency of claim 1, wherein the air outlet port is formed in the inner shell,
the air outlet port open/shut device includes a rotating plate rotatably installed in the inner shell so as to open/shut the air outlet port according to the rotation, and
the air outlet port open/shut device operating device has a lower end connected with the air outlet port open/shut device and includes a rotating shaft having an upper end protruded to an upper portion of the outer shell.

4. The helmet-type personal disaster relief device for supplying air in case of emergency of claim 1, further comprising:
a neck cover formed of a flexible material having elasticity and connected with a lower end of the helmet body so as to surround a neck of a wearer; and
a neck cover tension rope installed in the neck cover so as to control the amount of air discharged through a lower end of the neck cover.

5. The helmet-type personal disaster relief device for supplying air in case of emergency of claim 4, further comprising:
a shoulder cover formed of an insulating and flexible material and connected to the lower end of the neck cover so as to surround a neck and a shoulder of a wearer.

6. The helmet-type personal disaster relief device for supplying air in case of emergency of claim 1, wherein a wireless communication module transmitting a location of the wearer to an external control center and formed to allow a wearer to receive evacuation route information from the external control center is installed in the outer shell.

7. The helmet-type personal disaster relief device for supplying air in case of emergency of claim 6, wherein the wireless communication module is operated together with the air outlet port open/shut device so that the wireless communication module is operated while the air outlet port open/shunt device opens the air outlet port.

8. The helmet-type personal disaster relief device for supplying air in case of emergency of claim 1, wherein the outer shell is provided with an emergency light operated when a fire alarm device installed in a building rings.

9. The helmet-type personal disaster relief device for supplying air in case of emergency of claim 1, wherein the outer shell is provided with a lamp so as to secure a wearer's field of vision.

10. The helmet-type personal disaster relief device for supplying air in case of emergency of claim 1, wherein the helmet body is formed of a flexible material and includes an air storage pack formed of a flexible material and forming the air storage space (S).

11. The helmet-type personal disaster relief device for supplying air in case of emergency of claim 1, wherein the compressed air stored in the air storage space (S) is discharged to the breathing space (H) from the air storage space (S) by operating the air outlet port open/shut device to maintain an air pressure of the breathing space (H) so as to be higher than the external air pressure of the helmet body.

12. The helmet-type personal disaster relief device for supplying air in case of emergency of claim 1, wherein the compressed air stored in the air storage space (S) is compressed oxygen.

13. The helmet-type personal disaster relief device for supplying air in case of emergency of claim 1, wherein an inside of the helmet body is further provided with a carbon dioxide absorbing member and a dehumidifying agent.
